(19) United States
(12) Patent Application Publication
(10) Pub. No.: US 2020/0082737 A1
(43) Pub. Date: Mar. 12, 2020

(54) BRAILLE DEVICE CONTROL SYSTEM, BRAILLE DEVICE, AND CONTROL METHOD OF BRAILLE DEVICE CONTROL SYSTEM

(71) Applicant: KONICA MINOLTA, INC., Tokyo (JP)

(72) Inventor: Kiyohiko KOBAYASHI, Tokyo (JP)

(73) Assignee: KONICA MINOLTA, INC., Tokyo (JP)

(21) Appl. No.: 16/516,743

(22) Filed: Jul. 19, 2019

(30) Foreign Application Priority Data
Sep. 6, 2018 (JP) 2018-166731

(51) Int. Cl. G09B 21/00; G06F 3/041; G06F 3/033

(52) U.S. Cl. CPC G09B 21/004; G06F 3/041; G06F 2203/0331; G09B 21/005; G06F 3/033

(57) ABSTRACT

A main body processor of a braille device control system transmits information corresponding to a display content of a position touched by an operator's finger on a touch panel as braille information used for a first braille display and information corresponding to error information or status information of a main body apparatus as braille information used for s second braille display, to a braille device, and a braille device processor displays the received braille information used for the first braille display on the first braille display and the received braille information used for the second braille display on the second braille display.

### CROSS-REFERENCE TO RELATED APPLICATION

The entire disclosure of Japanese patent application No. 2018-166731, filed on Sep. 6, 2018, is incorporated herein by reference in its entirety.

### BACKGROUND

### 1. Technical Field

The present invention relates to a braille device control system, a braille device, and a control method of a braille device control system.

### 2. Description of Related Arts

Generally, with normal touch panels, visually impaired persons cannot perform operation. For such a problem, in the technology disclosed in Patent Literature 1 (JP 2004-271748A), a touch panel apparatus capable of switching a normal mode and a visually impaired person mode is disclosed. In this apparatus, an operator switches to the visually impaired person mode by wearing a headphone or operating a decision switch. Successively, in the visually impaired person mode, when the operator touches a touch panel, only the touched position information is notified to a control device without notifying touch information to the control device. The control device guides screen information corresponding to the position information by voice, and then, if the screen information is the desired screen information, the operator turns ON a decision switch other than the touch panel. In response to the ON of the decision switch, the touch panel apparatus notifies the control device of the touch information, whereby it is made possible to perform an operation similar to that in the normal mode.

Moreover, in the technology disclosed in Patent Literature 2 (JP 2000-172408A), an input device to be used by an operator having worn a finger cap capable of performing wireless communication is disclosed, and the following processes are executed. Upon touching a touch panel by an operator having worn the finger cap, on the touch panel side, a braille matrix signal corresponding to operation type information at the coordinate position of the touch is transmitted to the finger cap. Then, on the finger cap side, a three-dimensional braille pattern corresponding to this braille matrix signal is generated inside. The operator recognizes the kind of a key by tracing the braille pattern on the inside.

### SUMMARY

A main body apparatus that performs operation with a touch panel, displays various kinds of information with regard to the main body apparatus, for example, error information and status information such as data receiving, on an LED provided on a periphery of the touch panel, or displays them on a region of a part of the touch panel. During touch panel operation, healthy persons can recognize easily various kinds of information with regard to such a main body apparatus simultaneously. However, it is difficult for visually impaired persons to recognize them. With the technologies disclosed by Patent Literature 1 and Patent Literature 2, such a problem cannot be solved.

The present invention has been achieved in view of the above-described circumstances, and an object of the present invention is to provide a braille device control system in which a visually impaired person can share a main body apparatus including a touch panel that a healthy person uses.

To achieve the above-mentioned object, according to an aspect of the present invention, a braille device control system reflecting one aspect of the present invention includes a main body apparatus that receives an operation; and a braille device capable of performing wireless communication with the main body apparatus, wherein the main body apparatus includes a touch panel that displays an operation screen on a display surface and detects a touch by an operator onto the display surface, a main body communicator that performs wireless communication with the braille device, and a main body processor, wherein the braille device includes a finger cover that covers a fingertip of an operator, a braille device communicator that performs wireless communication with the main body communicator, a braille device processor, a first braille display disposed inside the finger cover and capable of displaying braille information, and a second braille display capable of displaying the braille information, wherein the main body processor transmits information corresponding to a display content of a position touched by an operator's finger on the touch panel as braille information used for the first braille display and information corresponding to error information or status information of the main body apparatus as braille information used for the second braille display, to the braille device, and wherein the braille device processor displays the received braille information used for the first braille display on the first braille display and the received braille information used for the second braille display on the second braille display.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A is a perspective view showing an appearance of a braille device control system.

FIG. 1B is a perspective view showing an appearance of a braille device.

FIG. 2 is a block diagram showing a hardware constitution of a main body apparatus.

FIG. 3 is a block diagram showing a hardware constitution of a braille device.

FIG. 4 is a cross-sectional schematic diagram of a periphery of a finger cover.

FIG. 5 shows an example of an operation key within an operation screen to be displayed on a touch panel.

FIG. 6 shows an example of braille image data used for braille corresponding to FIG. 5.

FIG. 7 shows an example of an error message displaying region being a region of a part of a touch panel and an LED display provided on a periphery of a touch panel.

FIG. 8 shows an example of braille image data used for braille corresponding to FIG. 7.

FIG. 9 is a flowchart showing control on a main body apparatus side.

FIG. 10 is a flowchart showing control on a braille device side.

### DETAILED DESCRIPTION OF EMBODIMENTS

Hereinafter, with reference to attached drawings, an embodiment of the present invention will be described in detail. However, the scope of the invention is not limited to the disclosed embodiments. In the description for the drawings, the same constitutional element is provided with the same reference symbol, and the overlapping description is omitted. Moreover, the dimensional ratios in the drawings are exaggerated on account of description, and, may be different from the actual ratios.

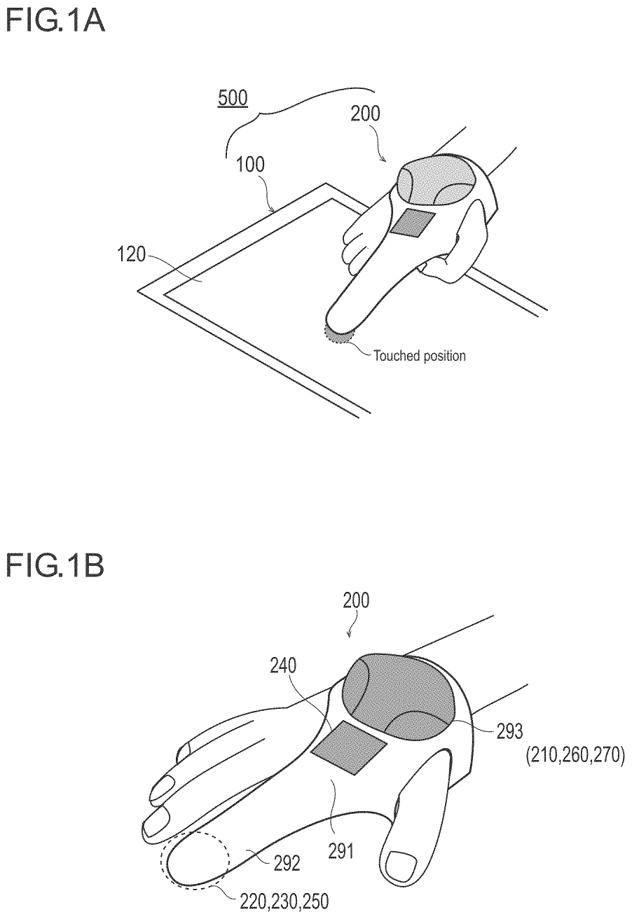

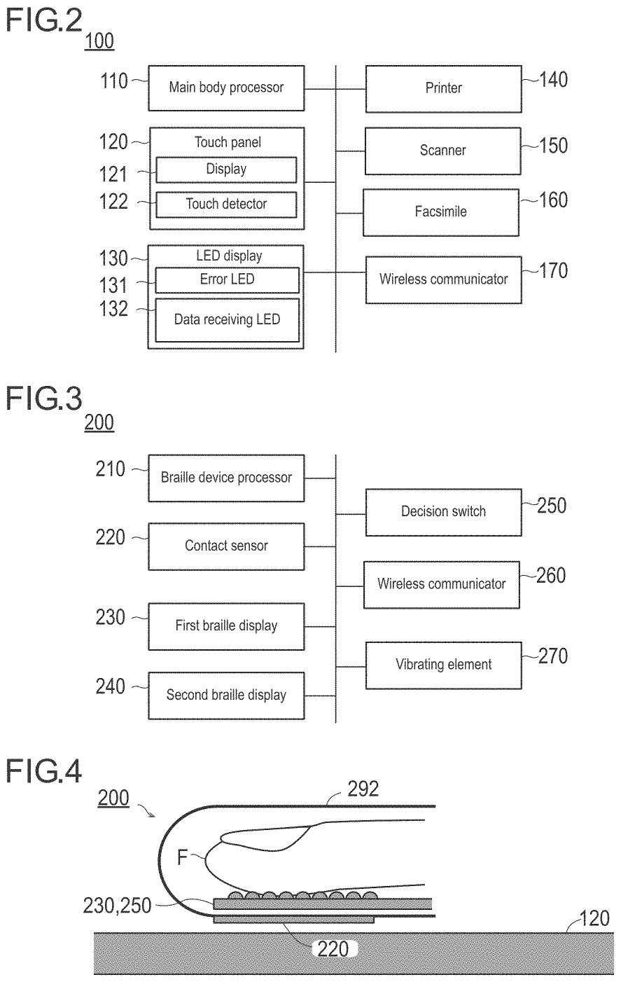

FIG. 1A is a perspective diagram showing an appearance of a braille device cooperating system 500 (also referred to as a braille device control system) according to the present embodiment. In FIG. 1A, a state where a braille device 200 is operating a touch panel 120, is shown. FIG. 1B is a perspective view showing an appearance of the braille device 200. FIG. 2 is a block diagram showing a hardware constitution of a main body apparatus 100. FIG. 3 is a block diagram showing a hardware constitution of the braille device 200. As shown in FIG. 1A through FIG. 3, the braille device cooperating system 500 includes the main body apparatus 100 and the braille device 200.

(Main Body Apparatus 100)

The main body apparatus 100 is, for example, a composite machine (MFP: Multi-Function Peripherals). As shown in FIG. 2, the main body apparatus 100 includes a main body processor 110, a touch panel 120, an LED display 130, a printer 140, a scanner 150, a facsimile 160, and a wireless communicator 170.

The main body processor 110 includes a CPU, a RAM, and a ROM. Moreover, the main body processor 110 may further include an auxiliary memory device, such as an HDD (hard disk drive). The ROM stores various programs and various kinds of data beforehand, and the RAM memorizes a program and data temporarily as a work region. The CPU controls the whole main body apparatus 100 in accordance with programs.

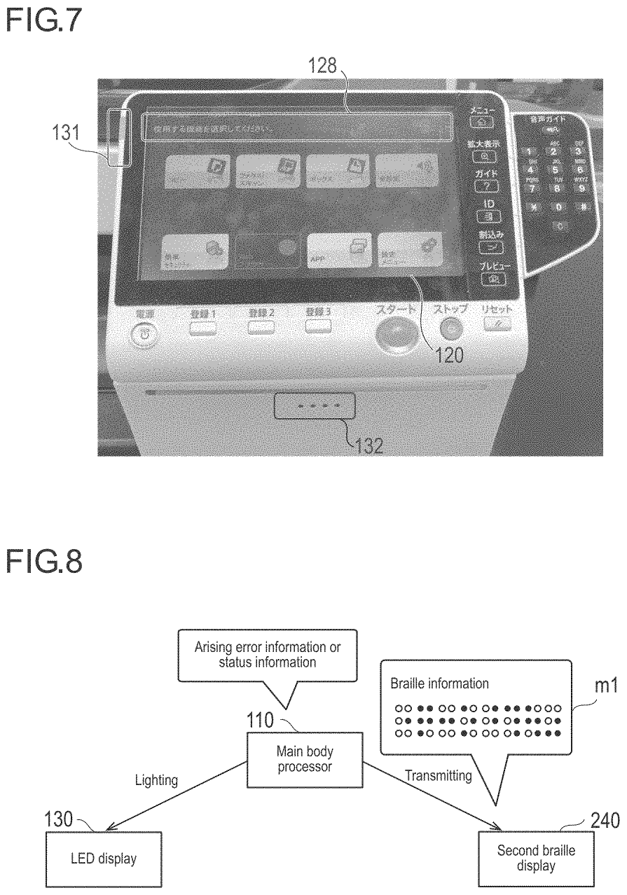

The touch panel 120 is also referred to as a touch screen and includes a display 121 including a liquid crystal screen etc. and a touch detector 122 that detects an operation of an operator's finger. Moreover, an error message displaying region 128 (refer to FIG. 7 mentioned later) being a region of a part of the touch panel 120 displays various kinds of information with regard to the main body apparatus 100. In this connection, the error message displaying region 128 may be disposed on a periphery of the touch panel 120.

The touch detector 122 is, for example, an electrostatic capacitance type detector. In the case where an operator's finger comes in contact with a surface of the touch panel 120, the touch detector 122 detects existence or nonexistence of contact of the finger and its contact position (coordinates) on the basis of a change of electrostatic capacitance. Moreover, the touch detector 122 corresponds also to detection of simultaneous touch (multi-touches) with a plurality of fingers.

The LED display 130 includes an error LED 131 and a data receiving LED 132. For example, the error LED 131 is turned on in the case where an error arises in each of later-mentioned functions of the printer 140, the scanner 150, the facsimile 160, and the like in the main body apparatus 100. On the other hand, the data receiving LED 132 is turned on in the case of receiving data with regard to a printer function and the like in the main body apparatus 100 through communication from an external device, such as a personal computer. In this connection, as shown in FIG. 7, the LED display 130 may be disposed on a periphery of the touch panel 120 and is not asked in the matter of a position, shape, and the like.

The printer 140 forms an image on a sheet with a well-known electrophotographying system or ink jet system on the basis of print data.

The scanner 150 includes an original document glass on which an original document is placed, a light source that irradiates light to the original document, an optical system such as a lens, and an optical element such as a CCD that generates image data from reflected light. The scanner 150 reads out an image on an original document placed on the original document glass or an image on an original document conveyed by an automatic document conveying apparatus and generates image data.

The facsimile 160 includes a modem and a data accessor. The modem is connected to the data accessor and a communication line network, such as a telephone line. The data accessor has a function that outputs a pulse signal corresponding to a counter party's telephone number. The facsimile 160 performs transmission of image data with a facsimile of a counter party through a communication line network.

The wireless communicator 170 includes a wireless communication interface, such as BLE (Bluetooth Low Energy), Bluetooth (registered trademark), IEEE802.11, IrDA. Moreover, as short-distance wireless communication, used may be communication methods, such as FeliCa (registered trademark), ISO/IEC 14443 (communication method of MIFARE (registered trademark)), and ISO/IEC 18092 (NFC: Near Field Communication).

In this connection, separately from the above wireless communication interface, as wired interfaces, the main body apparatus 100 may include an interface, such as an interface for LAN connection according to standards, such as Ethernet (registered trademark) and FDDI, a serial interface, such as USB and IEEE 1394, and a parallel interface, such as SCSI and IEEE1284.

(Braille Device 200)

As shown in FIG. 1A, FIG. 1B, and FIG. 3, the braille device 200 includes a braille device processor 210, a contact sensor 220, a first braille display 230, a second braille display 240, a decision switch 250 used for selection operation, a wireless communicator 260, and a vibrating element 270.

As shown in FIG. 1A and FIG. 1B, the braille device 200 is configured to be worn on a hand of an operator such as a visually impaired person and includes a glove main body 291, a finger cover 292 that covers an index finger in a state where the braille device 200 is worn on a hand, and a unit case 293 provided on a portion of the back of the hand of this glove main body 291. The braille device 200 is worn on an operator's hand with a wrist band (not shown) of the glove main body 291. The glove main body 291 is connected to the finger cover 292, and these are constituted integrally.

At a tip portion of the finger cover 292, the contact sensor 220, the first braille display 230, and the decision switch 250 are provided, and in the inside of the unit case 293, the braille device processor 210, the wireless communicator 260, and the vibrating element 270 are provided. These are supplied with electric power from a secondary battery (not shown) provided in the unit case 293. Moreover, as shown in FIG. 1B etc., the second braille display 240 is provided on the outside of the glove main body 291 integrated with the finger cover 292.

(Braille Device Processor 210, Wireless Communicator 260)

The braille device processor 210 includes a CPU, a RAM, and a ROM. The wireless communicator 260 performs communication with the wireless communicator 170 through wireless communication. These functions are similar to those of the main body processor 110 and the wireless communicator 170, and description for them is omitted.

(Contact Sensor 220)

The contact sensor 220 is disposed at a position corresponding to a belly of a finger of the finger cover 292 and detects a matter that the outside of the finger cover 292 comes in contact with an object, such as a surface of the touch panel 120. The contact sensor 220 may be, for example, a mechanical sensor, such as a microswitch or a pressure sensor, or may be an optical sensor. Moreover, in the case of using a pressure sensor, the pressure sensor may be made to determine such that, in the case where the outside of the finger cover 292 has come in contact with an object with a predetermined pressure or more, the outside of the finger cover 292 has contacted. In the case where an operator having worn the braille device 200 has touched a certain object such as the touch panel 120 with a tip of the finger cover 292, the contact sensor 220 detects the touch.

(First Braille Display 230)

The first braille display 230 is disposed inside the finger cover 292 and displays (embodies) a three-dimensional braille pattern that makes an operator cause a feel of braille. FIG. 4 is a cross-sectional schematic diagram of a periphery of the finger cover 292. As shown in FIG. 4, the first braille display 230 is provided with a large number of pins that makes a fingertip feel a tactile sense, and the protruding amount in a height direction of each of the pins can be changed individually by a piezoelectric element. The density (resolution) of the pins is constituted with a density higher than the pitch (2 to 3 mm) of general braille, and in addition to a braille pattern, it is possible to display text information and a simple image.

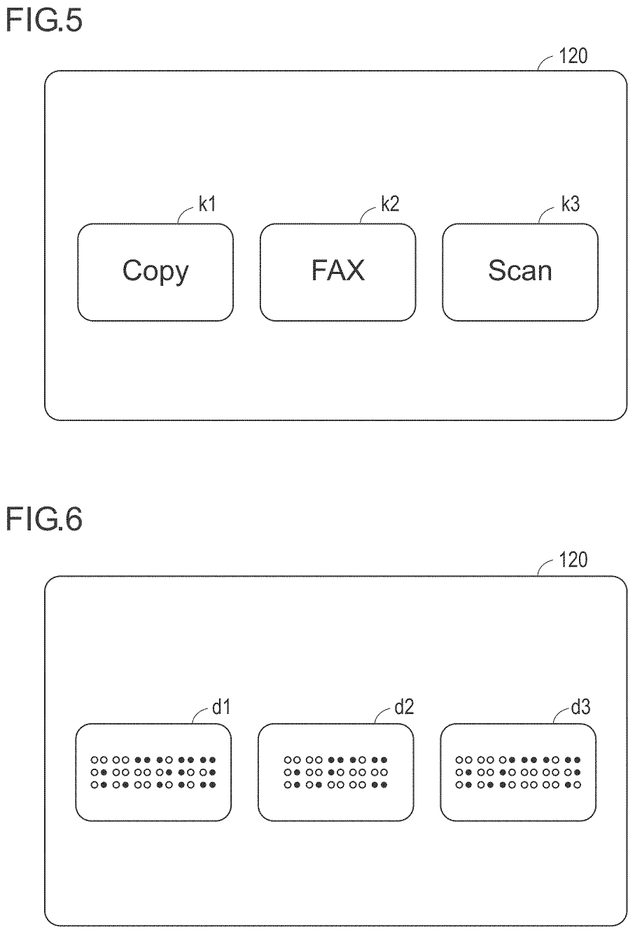

Hereinafter, with reference to FIG. 5 and FIG. 6, description is given to an example of a braille pattern to be displayed on the first braille display 230. FIG. 5 shows an example of an operation screen displayed on the touch panel 120. On the operation screen, a plurality of operation keys k1 to k3 (hereafter, these are also collectively called “operation key k”) are arranged and displayed visually. FIG. 6 shows braille image data d1 to d3 (hereafter, these are also collectively called “braille image data d”) used for braille corresponding to FIG. 5. Braille information included in each of the braille image data d1 to d3 corresponds to character data shown in a corresponding one of the operation keys k1 to k3. In this connection, this correspondence relation is merely an exemplification, the respective character data of the operation keys k1 to k3 and the braille image data d1 to d3 do not need to correspond to one to one and it may be sufficient if the respective meaning contents correspond to each other. For example, the braille number (number of characters) of each of the braille image data d1 to d3 may be made less than the number of characters of the character data of each of the operation keys k1 to k3. Both the image data used for the screen of FIG. 5 and the image data used for the braille of FIG. 6 are memorized in a memory of the main body processor 110.

At the time of a normal mode, by touching each of the operation keys k with a finger, a process corresponding to each of the operation keys k is executed. For example, by touching the operation key k1, an operation screen is changed to a setting screen with regard to copy. In a braille device correspondence control mentioned later, by a matter that an operator having worn the braille device 200 touches an operation key k on the operation screen with the finger cover 292, braille image data d corresponding to the display content of the touched position on the touch panel is displayed on the first braille display 230. In concrete terms, for example, by touching any position within a frame (square frame) of the operation key k1 on the surface of the touch panel 120 with the finger cover 292, the braille image data d1 corresponding to the operation key k1 is transmitted from the main body apparatus 100 to the braille device 200 through wireless communication. Then, the braille device 200 displays the received braille image data d1 on the first braille display 230. In this connection, in the example shown FIG. 6, the braille image data d1 includes six pieces of data in which each piece of data is represented by a combination of six pins. With a sliding operation within the operation key k1 by an operator, the six pieces of data may be displayed while being scrolled. Moreover, the braille image data d1 includes not only braille information, but also may be made to include figures, such as frame lines surrounding the whole of them.

(Second Braille Display 240)

The second braille display 240 is disposed outside the glove main body 291 integrated with the finger cover 292 and displays (embodies) a three-dimensional braille pattern that makes an operator cause a feel of braille. Similarly to the first braille display 230, the second braille display 240 is provided with a large number of pins that makes a fingertip feel a tactile sense, and the protruding amount in a height direction of each of the pins can be changed individually by a piezoelectric element. The density (resolution) of the pins is constituted with a density higher than the pitch (2 to 3 mm) of general braille, and in addition to a braille pattern, it is possible to display text information and a simple image. Moreover, the second braille display 240 makes it possible to display various kinds of information with regard to the main body apparatus 100, for example, braille information with regard to error information and status information, such as data receiving, and these pieces of information are scroll-displayed by the second braille display 240. With this, it is possible for a visually impaired person to grasp the various kinds of information with regard to the main body apparatus 100 while selectively operating the touch panel 120. In this connection, without being disposed on the glove main body 291, the second braille display 240 may be constituted with a separate body, or may be disposed on a main body apparatus 100 side.

Hereinafter, with reference to FIG. 7 and FIG. 8, description is given for an example of a braille pattern to be displayed in the second braille display 240. FIG. 7 shows an example of the error message displaying region 128 being a region of a part of the touch panel 120 and the LED display 130 provided on a periphery of the touch panel 120. In the case where there have been various kinds of information with regard to the main body apparatus 100, an error message is disposed on the error message displaying region 128 being a region of a part of the touch panel 120 and is visually being displayed. Moreover, in the case where there has been status information, such as data receiving, the status information is visually being displayed on the LED display 130 provided on a periphery of the touch panel 120.

FIG. 8 shows an example of braille image data used for braille corresponding to FIG. 7. An operator having worn the braille device 200 touches an operation screen with the finger cover 292. At this time, for example, in the case where the data receiving LED 132 is lighting on because data is being transmitted to the main body apparatus 100 from an external device such as a personal computer, the main body processor 110 transmits a matter that “data is being received” as braille image data m1 to the second braille display 240. With this, by converting visual contents into braille information, a visually impaired person can grasp various kinds of information with regard to the main body apparatus 100. In this connection, this correspondence relation is merely an exemplification, characters displayed on the error message displaying region 128 and contents intended by the LED display 130 and the braille image data m1 do not need to correspond to one to one, and it may be sufficient if the respective meaning contents correspond to each other. For example, the braille image data m1 may be less than the number of characters of character data having been displayed on the error message displaying region 128.

(Decision Switch 250)

The decision switch 250 is a pressure sensor disposed so as to be superimposed on the first braille display 230. In the case where a predetermined pressure or more is detected by the pressure sensor due to a matter that an operator pushes a finger F downward, the braille device processor 210 determines that the decision switch 250 has been turned ON by the operator. In this connection, the decision switch 250 is not limited to this and may be a tact switch to be operated by a free hand Moreover, in that case, this tact switch may be disposed on an upper portion of the unit case 293.

(Vibrating Element 270)

The vibrating element 270 is, for example, a small size motor in which an eccentricity weight is attached and is disposed inside the unit case 293. By receiving braille information (mentioned later) used for the second braille display, when braille information has been displayed (when starting) on the second braille display 240, the vibrating element 270 is made to vibrate. By making the braille device 200 vibrate by the vibrating element 270, an operator can grasp that the various kinds of information with regard to the main body apparatus 100 have been displayed on the second braille display 240. Moreover, as shown in FIG. 1B, in the case where the first braille display 230 and the second braille display 240 are mounted on the same braille device 200, an operator can read out braille information from the second braille display 240 by using a finger having not worn the braille device 200, after having sensed vibration. With this, while reading out braille information in the first braille display 230, simultaneously, an operator can read out braille information corresponding to various kinds of information with regard to the main body apparatus 100 in the second braille display 240.

(Control Method)

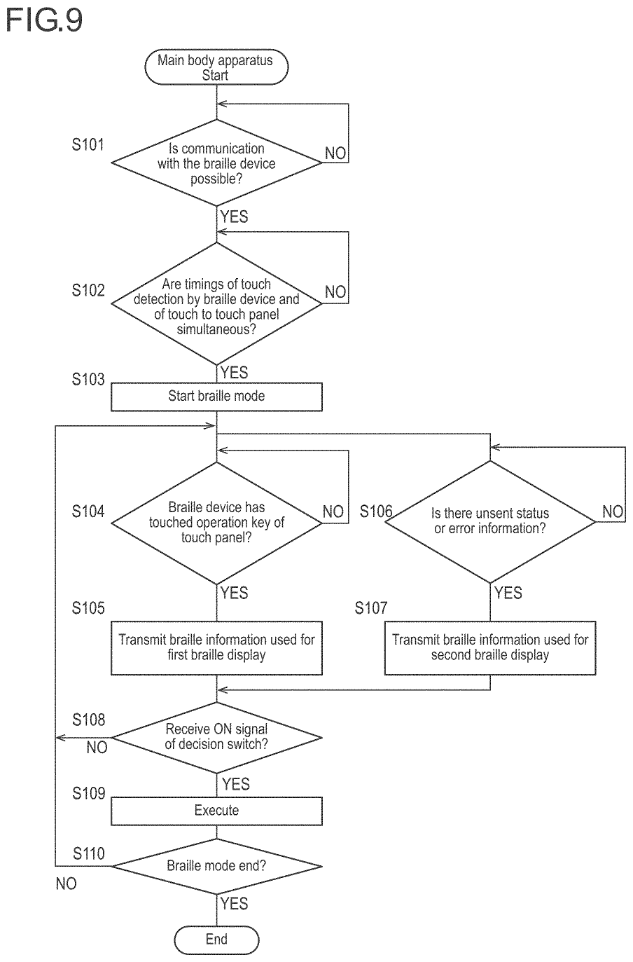

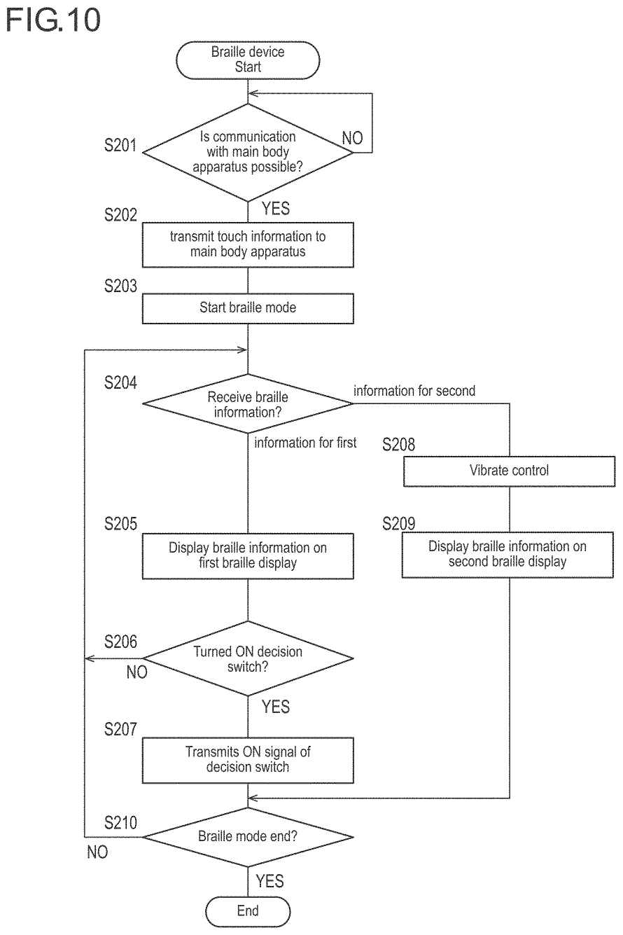

Hereinafter, with reference to FIG. 9 and FIG. 10, description is given for a control method of the braille device cooperating system 500. FIG. 9 is a flowchart showing control on a main body apparatus 100 side, and FIG. 10 is a flowchart showing control on a braille device 200 side.

(Control on Main Body Apparatus 100 Side)

(Step S101)

The main body processor 110 of the main body apparatus 100 determines whether communication with the braille device processor 210 is possible or not. In the case where wireless communication with the braille device processor 210 can be established (YES), the process is made to advance to Step S102. On the other hand, in the case where communication cannot be established (NO), the process is made to stand by.

(Step S102)

Here, the main body processor 110 receives sequentially the sensor information having been transmitted in real time in later-mentioned Step S202 by the braille device 200. Moreover, the main body processor 110 determines whether a touch is one made by the touching of the braille device 200 or not. In the case where the touch is one made by the touching of the braille device 200 (YES), the process is made to advance to Step S103. Otherwise (NO), the process is made to stand by. This determination is performed, for example, on the basis of whether a waveform showing a contact timing of the sensor information transmitted from the braille device 200 and a waveform showing a timing of a touch made to the touch panel 120 are the same or not.

In more concrete terms, in the case where a timing when the sensor information has changed non-contact to contact coincides with a timing when a touch has been detected in the main body apparatus 100, the main body processor 110 determines that the touch detected at Step S102 is one that has been touched by the braille device 200. For example, in the case of receiving sensor information with a cycle of 60 Hz from the braille device 200, if a timing when the sensor information has changed from non-contact to contact is the same cycle or has a difference of about one cycle (about 16 msec), the main body apparatus 100 determines that it is a touch by the braille device 200.

(Step S103)

The main body processor 110 starts a braille mode. Moreover, in response to the determination of the start of the braille mode, a message of the start of the braille mode is transmitted from the main body apparatus 100 to the braille device 200.

(Step S104)

The main body processor 110 detects whether the braille device 200 has touched any one of the operation keys k of the touch panel 120 or not. In the case of having detected (YES), the process is made to advance to Step S105.

(Step S105)

The main body processor 110 transmits braille information used for the first braille display corresponding to the information corresponding to the display content of a position of the touch panel 120 touched by an operator, to the braille device 200. As a method of transmitting the information corresponding to the display content of a touched position as braille information used for the first braille display from the main body processor 110 to the braille device 200, there are the following methods. For example, a packet to be transmitted is made to include a flag (for example, port number) showing a matter of being braille information used for the first braille display together with text information corresponding to braille information. In this connection, in the case where the second braille display 240 is constituted with a separate body from the first braille display 230 and a communication interface for the second braille display is provided separately from a communication interface (wireless communicator 260) for a braille device main body, the braille information used for the first braille display and the braille information used for the second braille display may be transmitted to the respective corresponding communication interfaces.

(Step S106)

Here, in the case where various kinds of information with regard to the error information or status information of the main body apparatus 100 have been renewed (YES) or there is the unsent error or status information, the main body processor 110 advances the process to Step S107. The renewal of the various kinds of information with regard to the error information is a case where the error message displayed on the error message displaying region 128 being a region of a part of the touch panel 120 has been renewed. Moreover, the renewal of the various kinds of information with regard to the status information is a case where the information visually displayed on the LED display 130 provided on a periphery of the touch panel 120 has been renewed, for example, is a case of having started receiving data from an external device and being receiving. As a method of transmitting the renewal of the various kinds of information from the main body processor 110 to the braille device 200 is, for example, a method of making a transmission packet include a flag (for example, port number) showing a matter of being braille information used for the second braille display together with text information corresponding to braille information. In this connection, at this time, when performing wireless communication with the braille device 200, by acquiring the ID information of the braille device 200, it may be omitted to transmit repeatedly the already-transmitted error information or status information. For example, for the occurred error information or status information, the main body processor 110 records the transmission history to braille device 200, and, on the basis of the transmission history, the main body processor 110 determines whether to have transmitted or whether not to have sent.

(Step S107)

The main body processor 110 transmits braille information used for the second braille display corresponding to the contents of the various kinds of information with regard to the error information or status information of the main body apparatus 100 being visually displayed on the LED display 130 provided on a periphery of the touch panel 120, to the braille device 200.

(Step S108)

The main body processor 110 waits for receiving an ON signal of the decision switch 250. In the case of having received the ON signal (YES), the process is made to advance to Step S109. On the other hand, in the case of having not received, the process is made to return to Step S104.

(Step S109)

In response to the receiving of the ON signal of the decision switch 250 (corresponding to later-mentioned step S207), at the moment, the main body processor 110 executes the process of the function corresponding to an operation key k touched by the braille device 200.

(Step S110)

In the case where the wireless communication with the braille device 200 has been canceled, or in the case where a touch operation has been made by devices other than the braille device 200, the main body processor 110 ends the braille mode of the touch panel 120, ends the process (end), and executes the normal touch process. For example, after that, in the case where an operation key k of the operation screen has been touched, a process corresponding to the operation key k will be executed. Moreover, in response to determination of the end of the braille mode, a message of the end of the braille mode is transmitted from the main body apparatus 100 to the braille device 200.

(Control on Braille Device 200 Side)

(Step S201)

As shown in FIG. 10, the braille device processor 210 determines whether communication with the main body apparatus 100 is possible or not. In the case where the wireless communication for example by BLE can be established with the main body apparatus 100 (YES), the process is made to advance to Step S202. On the other hand, in the case where communication cannot be established (NO), the process is made to stand by.

(Step S202)

The braille device processor 210 monitors the output of the contact sensor 220 and transmits in real time sensor information, i.e., the information with regard to the contact timing to the touch panel 120, to the main body apparatus 100. This data to be transmitted is one that the output of the contact sensor 220 is converted into a signal with a cycle of tens of Hz.

(Step S203)

A braille mode of the touch panel 120 is started by receiving a message of the start of the braille mode from the main body apparatus 100.

(Step S204)

The braille device processor 210 recognizes the display destination of the braille information received from the main body apparatus 100. In the case of having received the braille information used for the first braille display (information for the first), the process is made to advance to Step S205. In the case of having received the braille information used for the second braille display (information for the second), the process is made to advance to Step S208.

(Step S205)

The braille device processor 210 makes the first braille display 230 display the braille information used for the first braille display transmitted from the main body processor 110.

(Step S206)

In the case where the decision switch 250 has been turned ON (YES), the braille device processor 210 advances the process to Step S207. In the case where it has not been turned ON (NO), the process is made to return to Step S204.

(Step S207)

The braille device 200 transmits the ON signal of the decision switch 250 to the main body apparatus 100.

(Step S208)

In the case of having received the braille information used for the second braille display, the braille device processor 210 makes the vibrating element 270 vibrate for a fixed period and makes an operator recognize that braille information will be displayed on the second braille display 240.

(Step S209)

The braille device processor 210 makes the second braille display 240 display the braille information used for the second braille display transmitted from the main body processor 110. At this time, the braille information is scroll-displayed. Moreover, this scroll-display of the braille information may be performed repeatedly. Moreover, a sensor is provided in the vicinity of the second braille display 240. Then, in the case of having detected that an operator's finger has been placed on the second braille display 240, the scroll-display may be made to start.

(Step S210)

Due to a matter that the braille device 200 is separated from the touch panel 120, the braille device processor 210 switches the braille mode of the braille device 200 to an invalid state. Moreover, in the case of having received a message of the end of the braille mode from the main body apparatus 100, the braille device processor 210 ends the braille mode and ends the process (end).

Moreover, the braille device processor 210 makes the first braille display 230 and the second braille display 240 a non-use state. For example, by lowering all the pins of the first braille display 230 to the lowest point, an operator can recognize as an invalid state, and in addition, after that, the operation of the first braille display 230 is stopped.

In this way, in the present embodiment, the main body processor 110 transmits the information corresponding to the display content of a position of the touch panel 120 touched by an operator's finger as braille information used for the first braille display and the information corresponding to the error information or status information of the main body apparatus 100 as braille information used for the second braille display. Moreover, the braille device processor 210 displays the received braille information used for the first braille display on the first braille display 230 and displays the braille information used for the second braille display on the second braille display 240. With this, at the time of selection operation of the touch panel 120, from the display contents of the first braille display 230, or the display contents of the second braille display 240, an operator recognizes the display content of an operation panel with the braille information corresponding to a position touched by the operator on the touch panel 120 and, in addition, can recognize the error information or status information of the main body apparatus 100 displayed other than the touched position of the operation panel. With such a constitution, a visually impaired person can share a main body apparatus including a touch panel that a healthy person uses.

With regard to the constitution of each of the main body apparatus 100 of the braille device control system and the braille device 200 described in the above, the main constitution has been described in order to describe the feature of the above-described embodiment. Accordingly, the constitution is not limited to the above-described constitution, and within a scope of claims, various modifications can be made. Moreover, the constitution equipped in a general main body apparatus and braille device is not excluded.

Although embodiments of the present invention have been described and illustrated in detail, the disclosed embodiments are made for purpose of illustration and example only and not limitation The scope of the present invention should be interpreted by terms of the appended claims.

What is claimed is:

1. A braille device control system, comprising:
a main body apparatus that receives an operation; and
a braille device capable of performing wireless communication with the main body apparatus,
wherein the main body apparatus includes a touch panel that displays an operation screen on a display surface and detects a touch by an operator onto the display surface, a main body communicator that performs wireless communication with the braille device, and a main body processor,
wherein the braille device includes a finger cover that covers a fingertip of an operator, a braille device communicator that performs wireless communication with the main body communicator, a braille device processor, a first braille display disposed inside the finger cover and capable of displaying braille information, and a second braille display capable of displaying the braille information,
wherein the main body processor transmits information corresponding to a display content of a position touched by an operator's finger on the touch panel as braille information used for the first braille display and information corresponding to error information or status information of the main body apparatus as braille information used for the second braille display, to the braille device, and
wherein the braille device processor displays the received braille information used for the first braille display on the first braille display and the received braille information used for the second braille display on the second braille display.

2. The braille device control system according to claim 1, wherein the braille device further includes a vibrating element, and, when having received braille information used for the second braille display, the braille device processor makes the vibrating element vibrate.

3. The braille device control system according to claim 1, wherein the second braille display is disposed on a glove main body integrated with the finger cover in which the first braille display is disposed.

4. The braille device control system according to claim 1, wherein the braille device processor displays and scrolls braille information used for the second braille display on the second braille display.

5. The braille device control system according to claim 1, wherein the main body apparatus is a composite machine having at least a printer function, and the error information or the status information is error information or status information with regard to the printer function.

6. A braille device capable of performing wireless communication with a main body apparatus including a touch panel that detects a touch by an operator onto a display surface, comprising:
a finger cover that covers a fingertip of an operator;
a braille device communicator that performs wireless communication with the main body apparatus;
a braille device processor;
a first braille display disposed inside the finger cover and capable of displaying braille information; and
a second braille display capable of displaying the braille information,
wherein the braille device communicator receives braille information used for the first braille display corresponding to a display content of a position touched by an operator's finger on the touch panel and braille information used for the second braille display corresponding to error information or status information of the main body apparatus, from the main body apparatus, and
wherein the braille device processor displays the received braille information used for the first braille display on the first braille display and the received braille information used for the second braille display on the second braille display.

7. The braille device according to claim 6, wherein the braille device further includes a vibrating element, and, when having received braille information used for the second braille display, the braille device processor makes the vibrating element vibrate.

8. The braille device according to claim 6, wherein the second braille display is disposed on a glove main body integrated with the finger cover in which the first braille display is disposed.

9. The braille device according to claim 6, wherein the braille device processor displays and scrolls braille information used for the second braille display on the second braille display.

10. A control method of a braille device control system that includes a main body apparatus that receives an operation through a touch panel and a braille device capable of performing wireless communication with the main body apparatus, wherein the braille device includes a finger cover that covers a fingertip of an operator, a braille device communicator that performs wireless communication with a main body communicator, a braille device processor, a first braille display disposed inside the finger cover and capable of displaying braille information, and a second braille display capable of displaying the braille information, the control method comprising:
(a) transmitting information corresponding to a display content of a position touched by an operator's finger on the touch panel as braille information used for the first braille display from the main body apparatus to the braille device;
(b) transmitting information corresponding to error information or status information of the main body apparatus as braille information used for the second braille display from the main body apparatus to the braille device; and
(c) displaying the braille information, received by the braille device, used for the first braille display on the first braille display and the braille information, received by the braille device, used for the second braille display on the second braille display.
